(19) United States
(12) Patent Application Publication
(10) Pub. No.: US 2025/0306253 A1
(43) Pub. Date: Oct. 2, 2025

(54) VARIABLE WAVELENGTH INTERFERENCE FILTER

(71) Applicant: SEIKO EPSON CORPORATION, TOKYO (JP)

(72) Inventor: Kikuya MORITA, SHIOJIRI-SHI (JP)

(21) Appl. No.: 19/090,477

(22) Filed: Mar. 26, 2025

(30) Foreign Application Priority Data
Mar. 26, 2024 (JP) 2024-050212

(51) Int. Cl. G02B 5/20; G02B 5/28

(52) U.S. Cl. CPC G02B 5/204; G02B 5/28

(57) ABSTRACT

A variable wavelength interference filter includes: a first substrate; a first multi-layered film provided at the first substrate; a first electrode portion provided at an electrode region of the first multi-layered film; a second substrate disposed so as to be opposed to the first substrate; a second multi-layered film provided at the second substrate; a second electrode portion provided at an electrode region of the second multi-layered film so as to be opposed to the first electrode portion; and a coupling section disposed between a coupling region of the first multi-layered film and a coupling region of the second multi-layered film. A reflective region of the first multi-layered film and a reflective region of the second multi-layered film are disposed so as to be opposed to each other with a gap being interposed between them. The first multi-layered film and the second multi-layered film each include an optically stacked body and an end-surface layer formed at an end surface of the optically stacked body. At least a portion of the end-surface layer is electrically coupled to the first electrode portion or the second electrode portion.

The present application is based on, and claims priority from JP Application Serial Number 2024-050212, filed Mar. 26, 2024, the disclosure of which is hereby incorporated by reference herein in its entirety.

### BACKGROUND

### 1. Technical Field

The present disclosure relates to a variable wavelength interference filter.

### 2. Related Art

Typically, there is known a variable wavelength interference filter configured to allow light having a predetermined wavelength of incident light to pass through (for example, JP-A-2015-68886). The variable wavelength interference filter described in JP-A-2015-68886 includes: a first substrate and a second substrate that are opposed to each other; a first reflective film provided at the first substrate; a second reflective film provided at the second substrate and opposed to the first reflective film with a gap being provided between them; an electrostatic actuator configured to displace the first substrate toward the second substrate; and a capacitance detector used to detect the gap. The wavelength of the light that passes through is controlled by controlling the gap size between the first reflective film and the second reflective film.

In the variable wavelength interference filter described in JP-A-2015-68886, the first reflective film is comprised of a first multi-layered film provided at one surface of the first substrate, and the second reflective film is comprised of a second multi-layered film provided at one surface of the second substrate. In addition, in the variable wavelength interference filter described in JP-A-2015-68886, a pair of electrodes that constitute the electrostatic actuator and a pair of electrodes that constitute the capacitance detector are stacked at the first multi-layered film and the second multi-layered film respectively around the first reflective film and the second reflective film.

However, in a case of the variable wavelength interference filter described in JP-A-2015-68886, when the first multi-layered film and the second multi-layered film each include a thin layer made of an electrically conductive (or semi-electrically conductive) material, a parasitic capacitor between the electrode and the thin layer increases, which causes a trouble (for example, wavelength drift or the like) in controlling the gap size.

It is assumed that, in the variable wavelength interference filter described in JP-A-2015-68886, the first multi-layered film and the second multi-layered film are left only in a region where the first reflective film and the second reflective film are formed, and the first multi-layered film and the second multi-layered film are removed from the other region. In this case, manufacturing inconsistency of the gap size increases due to manufacturing inconsistency of each of the film thicknesses of the first multi-layered film and the second multi-layered film, which results in a deterioration in the accuracy of the transmitting wavelength.

### SUMMARY

A variable wavelength interference filter according to one aspect of the present disclosure includes a first substrate, a first multi-layered film provided at one surface of the first substrate and including a reflective region, an electrode region, and a coupling region that are regions differing from each other, a first electrode portion provided at the electrode region of the first multi-layered film, a second substrate disposed so as to be opposed to the first substrate, a second multi-layered film provided at one surface of the second substrate and including a reflective region, an electrode region, and a coupling region that are regions differing from each other, a second electrode portion provided at the electrode region of the second multi-layered film so as to be opposed to the first electrode portion, a signal being inputted into the second electrode portion, and a coupling film disposed between the coupling region of the first multi-layered film and the coupling region of the second multi-layered film and configured to couple the first substrate and the second substrate to each other, in which the reflective region of the first multi-layered film and the reflective region of the second multi-layered film are disposed so as to be opposed to each other with a predetermined gap being interposed between the reflective region of the first multi-layered film and the reflective region of the second multi-layered film, the first multi-layered film and the second multi-layered film each include an optically stacked body stacked at the first substrate or the second substrate, and also each include an end-surface layer formed at an end surface of the optically stacked body, and at least a portion of the end-surface layer is electrically coupled to the first electrode portion or the second electrode portion.

### BRIEF DESCRIPTION OF THE DRAWINGS

FIG. 1 is a cross-sectional view illustrating a schematic configuration of a variable wavelength interference filter according to one embodiment of the present disclosure.

FIG. 2 is a plan view illustrating a schematic configuration of a first substrate that constitutes the variable wavelength interference filter according to the embodiment.

FIG. 3 is a plan view illustrating a schematic configuration of a second substrate that constitutes the variable wavelength interference filter according to the embodiment.

FIG. 4 is a diagram showing a method of manufacturing the variable wavelength interference filter according to the embodiment.

### DESCRIPTION OF EMBODIMENTS

Below, a variable wavelength interference filter 1 according to the present embodiment will be described with reference to the drawing.

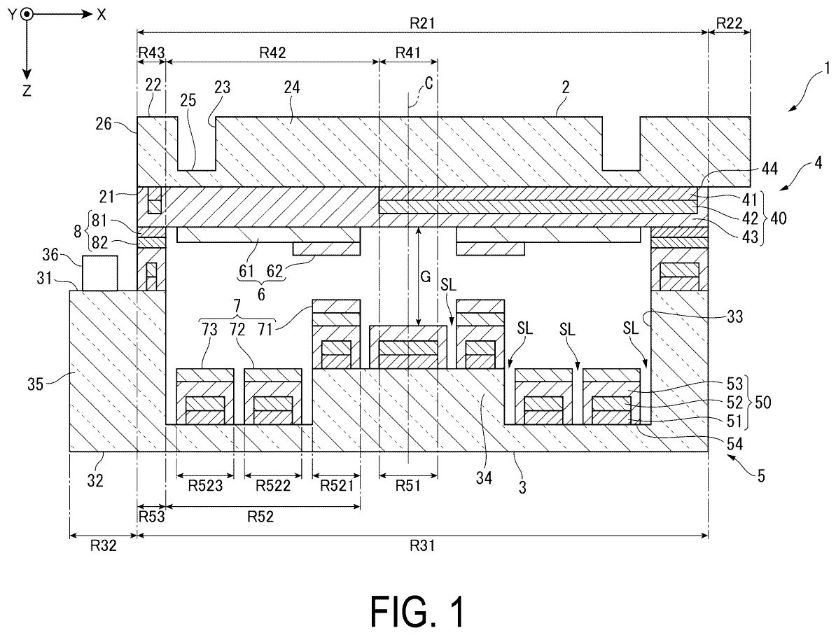

As illustrated in FIG. 1, the variable wavelength interference filter 1 according to the present embodiment includes: a first substrate 2 and a second substrate 3 disposed so as to be opposed to each other; a first multi-layered film 4 provided at the first substrate 2; a second multi-layered film 5 provided at the second substrate 3; a first electrode portion 6 provided at the first multi-layered film 4; a second electrode portion 7 provided at the second multi-layered film 5; and a coupling section 8 provided between the first multi-layered film 4 and the second multi-layered film 5.

Note that, in the variable wavelength interference filter 1, the first multi-layered film 4 and the second multi-layered film 5 include reflective regions R41 and R51 that are opposed to each other as described later. In the variable wavelength interference filter 1, the reflective regions R41 and R51 that are opposed to each other constitute a filter region, and the wavelength (that is, the transmitting wavelength of the variable wavelength interference filter 1) of light passing through the filter region is changed by changing a gap G between the reflective regions R41 and R51. This variable wavelength interference filter 1 can be used as a spectral filter in a spectrum measurement device or the like configured to perform spectrum measurement to the light from a measurement target, for example.

### Configuration of Variable Wavelength Interference Filter 1

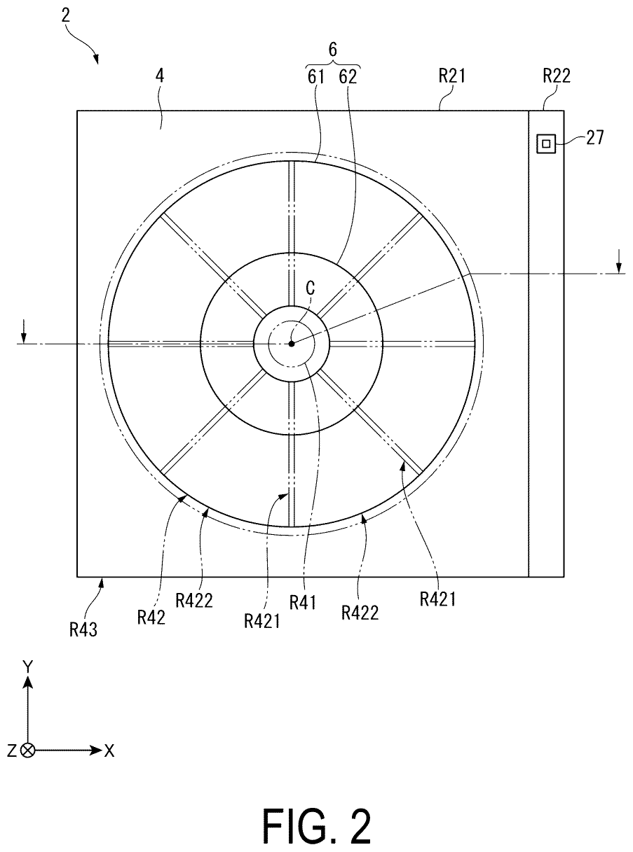

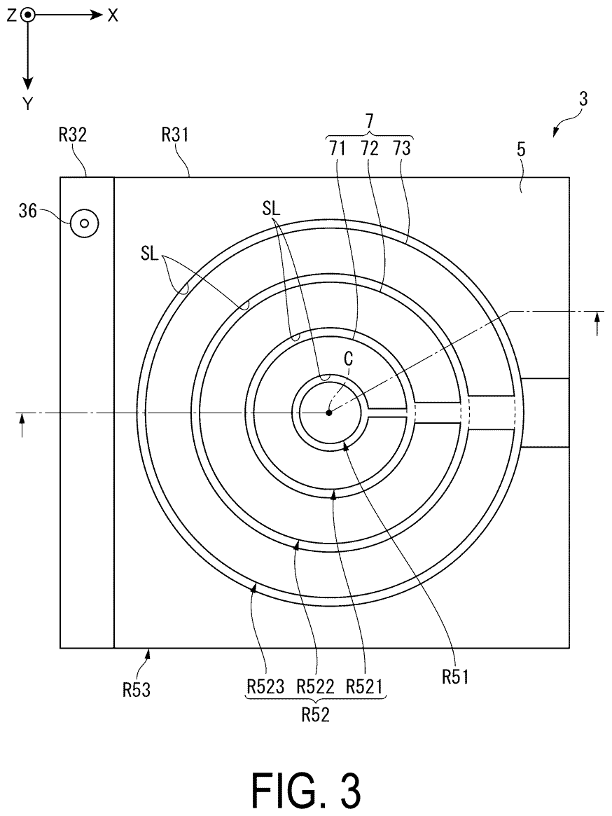

The configuration of the variable wavelength interference filter 1 will be described with reference to FIGS. 1 to 3. Note that the coupling section 8 is not illustrated in FIGS. 2 and 3. In addition, the cross-sectional view in FIG. 1 corresponds to each cross-sectional line in FIGS. 2 and 3.

In the following description, the Z direction represents a direction from the first substrate 2 toward the second substrate 3. The X direction represents one direction perpendicular to the Z direction. The Y direction represents a direction perpendicular to the Z direction and the X direction. The Z direction corresponds to a thickness direction of the variable wavelength interference filter 1. In addition, when the variable wavelength interference filter 1 is viewed from the Z direction, the filter region has a substantially circular shape with the center being the central axis C of the variable wavelength interference filter 1.

The first substrate 2 and the second substrate 3 are each made of a material such as a silicon substrate or a glass substrate transparent to light having a given wavelength region. In addition, the first substrate 2 and the second substrate 3 are configured integrally as a structured body including a cavity formed between these substrates.

Specifically, the first substrate 2 includes a first surface 21 that is opposed to the second substrate 3, and a second surface 22 that is a surface disposed at an opposite side from the first surface 21, as illustrated in FIG. 1. When the first substrate 2 is viewed from the Z direction, an annular groove 23 is formed in the second surface 22 of the first substrate 2 with the center being the central axis C of the variable wavelength interference filter 1. With this configuration, the first substrate 2 includes a movable unit 24 that is a portion where the reflective region R41 is provided, a diaphragm unit 25 that is a thin portion disposed so as to surround the movable unit 24, and a base section 26 configured to support the movable unit 24 through the diaphragm unit 25 so as to be able to be displaced.

The second substrate 3 includes a third surface 31 that is opposed to the first substrate 2, and a fourth surface 32 that is a surface disposed at an opposite side from the third surface 31. A recessed portion 33 having a predetermined depth is formed in the third surface 31 of the second substrate 3. The recessed portion 33 forms a cavity between the first substrate 2 and the second substrate 3. A pedestal portion 34 is provided in the center region within the recessed portion 33. The reflective region R51 is disposed in this pedestal portion 34, and the height of the pedestal portion 34 is set depending on the initial gap G between the reflective regions R41 and R51. In addition, the second substrate 3 includes a base section 35 that is a portion disposed around the recessed portion 33.

In addition, in the present embodiment, each of the first substrate 2 and the second substrate 3 more spreads than the regions that are opposed to each other. Specifically, the first surface 21 of the first substrate 2 includes an opposing region R21 that is opposed to the second substrate 3, and an adjoining region R22 adjacent to the opposing region R21. Similarly, the third surface 31 of the second substrate 3 includes an opposing region R31 that is opposed to the first substrate 2, and an adjoining region R32 adjacent to the opposing region R31.

The adjoining region R22 at the first surface 21 of the first substrate 2 is exposed from the first multi-layered film 4, and an alignment section 27 (see FIG. 2) is provided at this adjoining region R22. There is no particular limitation as to the specific configuration of the alignment section 27, and it is only necessary that there is an alignment mark or the like used to grasp the layout of the first substrate 2 in terms of manufacturing.

Similarly, the adjoining region R32 at the third surface 31 of the second substrate 3 is exposed from the second multi-layered film 5, and an alignment section 36 is provided at this adjoining region R32. There is no particular limitation as to the specific configuration of the alignment section 36, and it is only necessary that there is an alignment mark or the like used to grasp the layout of the second substrate 3 in terms of manufacturing.

The first multi-layered film 4 is provided in the opposing region R21 at the first surface 21 of the first substrate 2, and includes an optical stacking structure. In addition, the first multi-layered film 4 includes the reflective region R41, an electrode region R42, and a coupling region R43 that are regions differing from each other in plan view when viewed in the Z direction. Note that, in FIG. 1, the reference character of each of the regions of the first multi-layered film 4 is shown, as an example, at one side of the drawing, and these individual regions will be described in detail later.

The second multi-layered film 5 is provided in the opposing region R31 at the third surface 31 of the second substrate 3, and includes an optical stacking structure. In addition, the second multi-layered film 5 includes the reflective region R51, an electrode region R52, and a coupling region R53 that are regions differing from each other in plan view when viewed in the Z direction. Furthermore, the electrode region R52 includes a plurality of sub-electrode regions R521, R522, and R523. Note that, in FIG. 1, the reference character of each of the regions of the second multi-layered film 5 is shown, as an example, at one side of the drawing, and these individual regions will be described in detail later.

The first electrode portion 6 is provided in the electrode region R42 of the first multi-layered film 4. This first electrode portion 6 includes a substantially annular-shape GND electrode 61 provided across the entire electrode region R42, and a substantially annular-shape capacitance detecting electrode 62 provided at a portion, in the radial direction, of the GND electrode 61. The GND electrode 61 and the capacitance detecting electrode 62 are electrically coupled to each other, and are coupled to a control circuit through an electrode line or the like (not illustrated) to be at the ground potential.

Note that the GND electrode 61 is a metal oxide film made of indium tin oxide (ITO) or the like. In addition, the capacitance detecting electrode 62 is a metal film made of Au or the like.

The second electrode portion 7 is provided in the electrode region R52 of the second multi-layered film 5, and includes substantially annular-shaped electrodes 71 to 73 differing from each other. Below, in some cases, the electrode 71 may be referred to as a capacitance detecting electrode 71, the electrode 72 may be referred to as an inner-side drive electrode 72, and the electrode 73 may be referred to as an outer-side drive electrode 73.

The capacitance detecting electrode 71 is provided in the sub-electrode region R521, and is opposed to the capacitance detecting electrode 62. In addition, the capacitance detecting electrode 71 constitutes a capacitance detector together with the capacitance detecting electrode 62, and is coupled to a control circuit through an electrode line or the like (not illustrated). Here, the control circuit includes a detecting circuit configured to detect a capacitance between the capacitance detecting electrodes 62 and 71. A high frequency voltage is applied to the capacitance detecting electrode 71 by the detecting circuit in order to detect the capacitance.

Note that the capacitance detecting electrode 71 is a metal film made of Au or the like, as with the capacitance detecting electrode 62. An electrode layer that is a metal oxide film made of indium tin oxide (ITO) or the like exists between the capacitance detecting electrode 71 and the second multi-layered film 5.

The inner-side drive electrode 72 is provided in the sub-electrode region R522. The outer-side drive electrode 73 is provided in the sub-electrode region R523. The inner-side drive electrode 72 and the outer-side drive electrode 73 are each opposed to the GND electrode 61 of the first electrode portion 6. In addition, the inner-side drive electrode 72 and the outer-side drive electrode 73 constitute an electrostatic actuator together with the GND electrode 61, and are coupled to a control circuit through an electrode line (not illustrated). Here, signals (that is, drive signals) used to drive individual electrostatic actuators and differing from each other are applied, by the control circuit, to the inner-side drive electrode 72 and the outer-side drive electrode 73. Here, in each of the electrostatic actuators, electrostatic drawing force occurs between the inner-side drive electrode 72 and the GND electrode 61 and between the outer-side drive electrode 73 and the GND electrode 61 to displace the movable unit 24 of the first substrate 2 in the Z direction toward the second substrate 3, thereby changing the gap G.

Note that each of the inner-side drive electrode 72 and the outer-side drive electrode 73 is a metal oxide film made of indium tin oxide (ITO) or the like, as with the GND electrode 61.

The coupling section 8 includes a coupling film 81 provided in the coupling region R43 of the first multi-layered film 4, and a coupling film 82 provided in the coupling region R53 of the second multi-layered film 5. The coupling films 81 and 82 are coupled to each other. This coupling section 8 couples the first substrate 2 and the second substrate 3 to each other.

Note that a control circuit having a configuration similar to a known configuration can be used as the control circuit used to control the variable wavelength interference filter 1 according to the present embodiment. For example, by using a capacitance detector, the control circuit is able to detect the size of the gap G and also able to perform feedback control to each of the electrostatic actuators such that the gap G becomes a desired size. This enables the variable wavelength interference filter 1 to pass through light having a desired wavelength.

### Configuration of First Multi-Layered Film 4

The detailed configuration of the first multi-layered film 4 will be described with reference to FIGS. 1 and 2.

The first multi-layered film 4 includes the reflective region R41, the electrode region R42, and the coupling region R43 that are regions differing from each other in plan view when viewed in the Z direction as illustrated in FIGS. 1 and 2.

The reflective region R41 is disposed at the central region of the movable unit 24 of the first substrate 2 with the center being the central axis C of the variable wavelength interference filter 1.

The electrode region R42 is an annular region that surrounds the reflective region R41, and is disposed at the movable unit 24 and the diaphragm unit 25 of the first substrate 2. This electrode region R42 includes a plurality of partitioning-line regions R421 extending radially along the radial direction of the filter region, and a plurality of sub-electrode regions R422 divided by the partitioning-line regions R421. The first electrode portion 6 is stacked at the electrode region R42 over the plurality of sub-electrode regions R422.

The coupling region R43 is a region that surrounds the electrode region R42, and is disposed at the base section 26 in the opposing region R21 of the first substrate 2. The coupling film 81 (not illustrated in FIG. 2) is stacked at the coupling region R43.

In addition, the first multi-layered film 4 includes an optically stacked body 40 stacked at the first surface 21 of the first substrate 2, and an end-surface layer 44 formed at an end surface of the optically stacked body 40, as illustrated in FIG. 1.

Here, the optically stacked body 40 constitutes the reflective region R41, each of the sub-electrode regions R422 of the electrode region R42, and the coupling region R43. The end-surface layer 44 constitutes the partitioning-line region R421, thereby being formed at an end surface of the optically stacked body 40 in each of the sub-electrode regions R422. In other words, the optically stacked bodies 40 at the individual sub-electrode regions R422 are adjacent to each other with the end-surface layer 44 being interposed between them.

In addition, the optically stacked body 40 has a structure in which a high refractive-index layer and a low refractive-index layer are alternately stacked. For example, of the optically stacked body 40, a semiconductor layer 41 serving as the lowermost layer in contact with the first substrate 2 and a semiconductor layer 43 serving as the uppermost layer of the stacking structure are Si layers (silicon layers) that constitute the high refractive-index layer. An insulation-body layer 42 serving as an intermediate layer is a SiO₂ layer (silicon oxide layer) that constitutes the low refractive-index layer. That is, the optically stacked body 40 according to the present embodiment includes the insulation-body layer 42, and the semiconductor layers 41 and 43 stacked with the insulation-body layer 42 being interposed between them. The end-surface layer 44 is a semiconductor layer made of the same material as the semiconductor layer 43, and is preferable to be formed integrally with the semiconductor layer 43.

With the configuration described above, the semiconductor layers 41 and 43 of the optically stacked body 40 and the first electrode portion 6 at the semiconductor layer 43 are electrically coupled to each other with the end-surface layer 44 being interposed between them.

### Configuration of Second Multi-Layered Film 5

The detailed configuration of the second multi-layered film 5 will be described with reference to FIGS. 1 and 3.

The second multi-layered film 5 includes the reflective region R51, the electrode region R52, and the coupling region R53 that are regions differing from each other in plan view when viewed in the Z direction, as illustrated in FIGS. 1 and 3.

The reflective region R51 is disposed in the central region of the pedestal portion 34 of the second substrate 3, and is opposed to the reflective region R41 of the first multi-layered film 4. Note that the size of the gap G between the reflective regions R41 and R51 corresponds to the transmitting wavelength of the variable wavelength interference filter 1.

The electrode region R52 is an annular region that surrounds the reflective region R51, and is disposed in a region of the second substrate 3 that is opposed to the movable unit 24 and the diaphragm unit 25. The electrode region R52 is separated from the reflective region R51 and the coupling region R53, and includes a plurality of sub-electrode regions R521 to R523 divided so as to be independent of each other for each of the electrodes 71 to 73.

The sub-electrode regions R521 to R523 are annular regions disposed in the order from the inner side when the variable wavelength interference filter 1 is viewed in the Z direction. Specifically, the sub-electrode region R521 is disposed at the pedestal portion 34 of the second substrate 3, and the sub-electrode regions R522 and R523 are disposed in the recessed portion 33 of the second substrate 3. Here, an annular slit SL penetrating through the second multi-layered film 5 in the Z direction is formed between the reflective region R51 and the sub-electrode region R521, between the sub-electrode regions R521 and R522 adjacent to each other, between the sub-electrode regions R522 and R523 adjacent to each other, and between the sub-electrode region R523 and the coupling region R53.

The coupling region R53 is a region that surrounds the electrode region R52, and is disposed at the base section 35 in the opposing region R31 of the second substrate 3. The coupling film 82 (not illustrated in FIG. 3) is provided in the coupling region R43.

In addition, the second multi-layered film 5 includes an optically stacked body 50 stacked at the third surface 31 of the second substrate 3, and an end-surface layer 54 formed at an end surface of the optically stacked body 50, as illustrated in FIG. 1.

Here, the optically stacked body 50 constitutes the majority of the regions of the reflective region R51, the sub-electrode regions R521 to R523, and the coupling region R53. The end-surface layer 54 is formed at an end surface of the optically stacked body 50 in each of these regions.

In addition, the optically stacked body 50 has a structure in which the high refractive-index layer and the low refractive-index layer are alternately stacked, as with the optically stacked body 40 described above. For example, of the optically stacked body 50, a semiconductor layer 51 serving as the lowermost layer in contact with the second substrate 3 and a semiconductor layer 53 serving as the uppermost layer of the stacking structure are Si layers (silicon layers) that constitute the high refractive-index layer. An insulation-body layer 52 serving as an intermediate layer is a SiOs layer (silicon oxide layer) that constitutes the low refractive-index layer. That is, the optically stacked body 50 according to the present embodiment includes the insulation-body layer 52 and the semiconductor layers 51 and 53 stacked with the insulation-body layer 52 being interposed between them. The end-surface layer 54 is a semiconductor layer made of the same material as the semiconductor layer 53, and is preferable to be formed integrally with the semiconductor layer 53.

With the configuration described above, the optically stacked body 50 that constitutes each of the regions of the reflective region R51 and the coupling region R53 includes the semiconductor layers 51 and 53 that are electrically coupled to the end-surface layer 54.

In addition, in the sub-electrode regions R521 to R523, the semiconductor layers 51 and 53 of the optically stacked body 50 and the electrode 71, 72, or 73 at the semiconductor layer 53 are electrically coupled through the end-surface layer 54.

### Method of Manufacturing Variable Wavelength Interference Filter 1

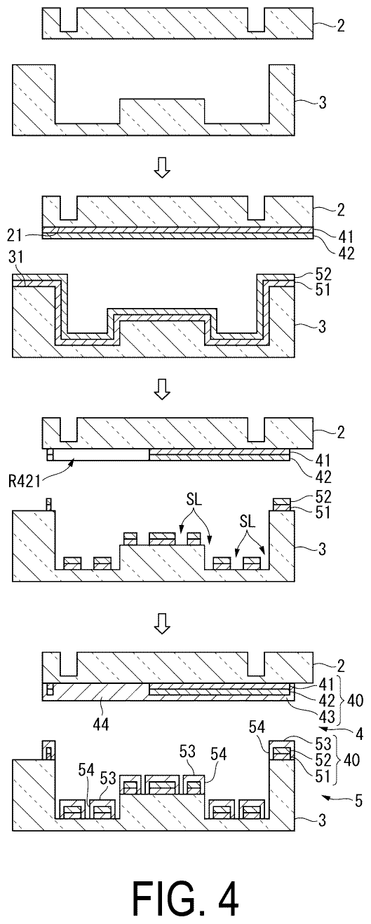

A method of manufacturing the variable wavelength interference filter 1 according to the present embodiment will be schematically described with reference to FIG. 4. Note that, in the following description, the reference characters similar to those in the embodiment described above will be used for the configuration corresponding to the embodiment described above.

First, the first substrate 2 and the second substrate 3 will be prepared (see the first section of FIG. 4). Next, the semiconductor layer 41 and the insulation-body layer 42 are formed over the entire surface of the first surface 21 of the first substrate 2. Similarly, the semiconductor layer 51 and the insulation-body layer 52 are formed over the entire surface of the third surface 31 of the second substrate 3 (see the second section of FIG. 4).

Next, a resist pattern is formed on the insulation-body layer 42 of the first substrate 2 to perform dry etching, thereby removing a region corresponding to the partitioning-line region R421 from the semiconductor layer 41 and the insulation-body layer 42.

Similarly, a resist pattern is formed on the insulation-body layer 52 at the second substrate 3 to perform dry etching, thereby removing regions (specifically, regions slightly larger than the slits SL) corresponding to the slits SL from the semiconductor layer 51 and the insulation-body layer 52 (see the third section of FIG. 4).

Next, a film of semiconductor material is formed over the first substrate 2. At this time, the semiconductor layer 43 is formed over the insulation-body layer 42, and the end-surface layer 44 is also formed over an end surface of the optically stacked body 40. This makes it possible to configure the first multi-layered film 4.

Similarly, a film of semiconductor material is formed over the second substrate 3. At this time, the semiconductor layer 53 is formed over the insulation-body layer 52, and the end-surface layer 54 is also formed over an end surface of the optically stacked body 50. This makes it possible to configure the second multi-layered film 5 (see the fourth section of FIG. 4).

After this, the first electrode portion 6 is formed over the first multi-layered film 4, and the second electrode portion 7 is formed in each of the electrode regions of the second multi-layered film 5. The method of forming the electrodes is not particularly limited, and it is possible to use a film forming method using a resist-pattern formation or dry etching. In addition, the alignment sections 27 and 36 are formed at the first substrate 2 and the second substrate 3 using a given method.

Lastly, the coupling film 81 is formed in the coupling region R43 of the first multi-layered film 4. The coupling film 82 is formed in the coupling region R53 of the second multi-layered film 5. An activation process or the like is performed to each of the front surfaces of the coupling films 81 and 82. The coupling films 81 and 82 are coupled to each other (see FIG. 1). At this time, by using the alignment sections 27 and 36, the first multi-layered film 4 and the second multi-layered film 5 are positioned to perform the coupling. This makes it possible to form the coupling section 8 and couple the first substrate 2 and the second substrate 3 to each other.

### Operation and Effect of Present Embodiment

As described above, the variable wavelength interference filter 1 according to the present embodiment includes the first substrate 2; the first multi-layered film 4 provided at the first surface 21 that is one surface of the first substrate 2 and including the reflective region R41, the electrode region R42, and the coupling region R43 that are regions differing from each other as viewed from the thickness direction of the first substrate 2; the first electrode portion 6 provided at the electrode region R42 of the first multi-layered film 4; the second substrate 3 disposed so as to be opposed to the first substrate 2; the second multi-layered film 5 provided at the third surface 31 that is one surface of the second substrate 3 and including the reflective region R51, the electrode region R52, and the coupling region R53 that are regions differing from each other as viewed from the thickness direction of the second substrate 3; the second electrode portion 7 provided at the electrode region R52 of the second multi-layered film 5 so as to be opposed to the first electrode portion 6; and the coupling section 8 disposed between the coupling region R43 of the first multi-layered film 4 and the coupling region R53 of the second multi-layered film 5 and configured to couple the first substrate 2 and the second substrate 3 to each other. Here, the reflective region R41 of the first multi-layered film 4 and the reflective region R51 of the second multi-layered film 5 are disposed so as to be opposed to each other with the predetermined gap G being interposed between them. The first multi-layered film 4 and the second multi-layered film 5 each include the optically stacked body 40, 50 stacked at the first substrate 2 or the second substrate 3, and also each include the end-surface layer 44, 54 formed at an end surface of the optically stacked body 40, 50. At least a portion of the end-surface layer 44, 54 is electrically coupled to the first electrode portion 6 or the second electrode portion 7.

In the present embodiment, of the first electrode portion 6 and the second electrode portion 7 that constitute the electrostatic actuator or the capacitance detector, the first electrode portion 6 is provided at the first multi-layered film 4, and the second electrode portion 7 is provided at the second multi-layered film 5. Here, the optically stacked body 40 of the first multi-layered film 4 is able to be electrically coupled to the first electrode portion 6 through the end-surface layer 44, which suppresses occurrence of a parasitic capacitor at the first multi-layered film 4. Similarly, the optically stacked body 50 of the second multi-layered film 5 is able to be electrically coupled to the second electrode portion 7 through the end-surface layer 54, which suppresses occurrence of a parasitic capacitor at the second multi-layered film 5. Thus, it is possible to suppress occurrence of a trouble (for example, wavelength drift or the like) in controlling the gap G between respective reflective regions R41 and R51 of the first multi-layered film 4 and the second multi-layered film 5.

In addition, in the present embodiment, the coupling section 8 is disposed between the coupling region R43 of the first multi-layered film 4 and the coupling region R53 of the second multi-layered film 5. The first substrate 2 and the second substrate 3 are coupled through the coupling section 8. Thus, even when there is a manufacturing inconsistency in individual film thicknesses of the first multi-layered film 4 and the second multi-layered film 5 in the variable wavelength interference filter 1, this manufacturing inconsistency in individual film thicknesses is absorbed by the coupling section 8, and does not affect the size of the gap G between the reflective regions R41 and R51. This makes it possible to improve the accuracy of the transmitting wavelength of the variable wavelength interference filter 1.

In the present embodiment, the optically stacked body 40 includes the insulation-body layer 42, and the semiconductor layers 41 and 43 stacked with the insulation-body layer 42 being interposed between them, and the end-surface layer 44 is electrically coupled to the semiconductor layers 41 and 43. Similarly, the optically stacked body 50 includes the insulation-body layer 52, and the semiconductor layers 51 and 53 stacked with the insulation-body layer 52 being interposed between them, and the end-surface layer 54 is electrically coupled to the semiconductor layers 51 and 53.

With such a configuration, it is possible to favorably suppress the occurrence of a parasitic capacitor in the first multi-layered film 4 and the second multi-layered film 5.

In addition, it is possible to integrally form the end-surface layer 44 and the semiconductor layer 43 that is the uppermost layer of the optically stacked body 40, and integrally form the end-surface layer 54 and the semiconductor layer 53 that is the uppermost layer of the optically stacked body 50. This makes it possible to easily form the first multi-layered film 4 and the second multi-layered film 5.

In the present embodiment, the electrode region R52 of the second multi-layered film 5 is separated from the reflective region R51 and the coupling region R53, and the second electrode portion 7 is electrically coupled to the end-surface layer 54 formed at the end surface of the optically stacked body 50 that constitutes the electrode region R52 of the second multi-layered film 5.

Such a configuration makes it possible to suppress the occurrence of the parasitic capacitor at the electrode region R52 of the second multi-layered film 5, and it is also possible to prevent short-circuiting and crosstalk between the electrode region R52 and the reflective region R51 and between the electrode region R52 and the coupling region R53.

In the present embodiment, the first electrode portion 6 and the second electrode portion 7 include capacitance detecting electrodes 62 and 71 configured to detect a capacitance between the first electrode portion 6 and the second electrode portion 7.

Such a configuration makes it possible to suppress the occurrence of a parasitic capacitor at the electrode region R52 of the second multi-layered film 5, which makes it possible to highly precisely detect the gap G by using the capacitance detecting electrodes 62 and 71.

In the present embodiment, the second electrode portion 7 includes the plurality of electrodes 71 to 73, and signals different from each other are inputted into the electrodes. The electrode region R52 of the second multi-layered film 5 is divided into the plurality of sub-electrode regions R521 to R523 corresponding respectively to the electrodes 71 to 73. The electrodes 71 to 73 are electrically coupled to the end-surface layer 54 formed at an end surface of the optically stacked body 50 that constitutes the sub-electrode regions R521 to R523.

Such a configuration makes it possible to suppress the occurrence of the parasitic capacitor at the sub-electrode regions R521 to R523, and also possible to prevent short-circuiting and crosstalk between the sub-electrode regions R521 to R523 adjacent to each other.

In the present embodiment, the optically stacked body 50 that constitutes the reflective region R51 of the second multi-layered film 5 includes the semiconductor layers 51 and 53 electrically coupled to the end-surface layer 54.

Such a configuration makes it possible to suppress the occurrence of the parasitic capacitor at the reflective region R51, which makes it possible to highly precisely control the size of the gap G between the reflective regions R41 and R51.

In the present embodiment, the electrode region R42 of the first multi-layered film 4 includes the plurality of sub-electrode regions R422 that are adjacent to each other with the end-surface layer 44 being interposed between them and are comprised of the optically stacked body 40.

Such a configuration makes it possible to efficiently prevent the occurrence of a parasitic capacitor over the wide range of the first multi-layered film 4 where the first electrode portion 6 serving as a ground electrode is provided.

In addition, in the present embodiment, the electrode region R42 is equally divided into the plurality of sub-electrode regions R422 by the plurality of end-surface layers 44 each extending radially when the first substrate 2 is viewed in the Z direction. This makes it possible to prevent the occurrence of a parasitic capacitor over the wide range without any imbalance.

In the present embodiment, the first substrate 2 includes: the opposing region R21 where the first multi-layered film 4 is provided, the the opposing region R21 being opposed to the second substrate 3; the adjoining region R22 adjoining the opposing region R21 and exposed from the first multi-layered film 4; and the alignment section 27 provided in the adjoining region R22. Similarly, the second substrate 3 includes: the opposing region R31 where the second multi-layered film 5 is provided, the opposing region R31 being opposed to the first substrate 2; the adjoining region R32 adjoining the opposing region R31 and exposed from the second multi-layered film 5; and the alignment section 36 provided in the adjoining region R32.

With such a configuration, the visibility of the alignment sections 27 and 36 is secured, which makes it easy to manufacture the variable wavelength interference filter 1.

### Modification Examples

The present disclosure is not limited to the embodiment described above, and modifications, improvements, and the like within the scope in which the object of the present disclosure can be achieved are included in the present disclosure.

In the embodiment described above, the optically stacked bodies 40 and 50 in the first multi-layered film 4 and the second multi-layered film 5 each have a three-layered structure. However, the number of optical layers that constitute the optically stacked body 40, 50 is not particularly limited. In addition, the material of each of the optical layers that constitute the optically stacked body 40, 50 is not limited to that given in the embodiment described above as an example. The material is only necessary to be a material that enables the reflective region R41, R51 to function.

Furthermore, in the optically stacked body 40, 50 according to the embodiment described above, at least any one of the semiconductor layers 41, 43, 51, and 53 may be replaced with a conductor layer having electrical conductivity. In addition, in the embodiment described above, the end-surface layers 44 and 54 are not limited to those integrally made of the same material as the semiconductor layers 43 and 53 that are the uppermost layers of the optically stacked bodies 40 and 50, and may be formed of a material differing from the semiconductor layer 43, 53.

In the embodiment described above, the arrangement of the partitioning-line regions R421 in the electrode region R42 of the first multi-layered film 4 is not particularly limited. In addition, the number of sub-electrode regions R422 is not limited. Furthermore, the electrode region R42 may not be divided. In addition, in the embodiment described above, the end-surface layer 44 may not be formed in the reflective region R41 or the coupling region R43.

That is, the end-surface layer 44 is only necessary to be formed at an end surface of the optically stacked body 40 in at least any portion of the first multi-layered film 4 so as to be electrically coupled to the first electrode portion 6.

In the embodiment described above, the second electrode portion 7 includes the plurality of electrodes 71 to 73 formed at the second multi-layered film 5. However, the configuration is not limited to this. For example, the second electrode portion 7 formed at the second multi-layered film 5 may be only a capacitance detecting electrode or may be only a drive electrode. Alternatively, the variable wavelength interference filter 1 may be configured so as not to include any capacitance detecting electrode.

In the embodiment described above, when the second electrode portion 7 includes a plurality of electrodes or one electrode into which the same signal is inputted, the electrode region R52 of the second multi-layered film 5 may not be divided. In addition, in the embodiment described above, the electrode region R52 of the second multi-layered film 5 may not be separated from the reflective region R51 or the coupling region R53. Furthermore, in the embodiment described above, the end-surface layer 54 may not be formed at the reflective region R51 or the coupling region R53.

That is, in the embodiment described above, it is only necessary that the end-surface layer 54 is formed at an end surface of the optically stacked body 50 at a least any portion of the second multi-layered film 5 so as to be electrically coupled to the second electrode portion 7.

In the embodiment described above, the alignment section 27, 36 is provided at the first substrate 2 and the second substrate 3. However, the present disclosure is not limited to this. The alignment section 27 (or 36) may be provided at either one of the first substrate 2 and the second substrate 3.

### Overview of Present Disclosure

(1) A variable wavelength interference filter according to one aspect of the present disclosure includes: a first substrate; a first multi-layered film provided at one surface of the first substrate and including a reflective region, an electrode region, and a coupling region that are regions differing from each other; a first electrode portion provided at the electrode region of the first multi-layered film; a second substrate disposed so as to be opposed to the first substrate; a second multi-layered film provided at one surface of the second substrate and including a reflective region, an electrode region, and a coupling region that are regions differing from each other; a second electrode portion provided at the electrode region of the second multi-layered film so as to be opposed to the first electrode portion, a signal being inputted into the second electrode portion; and a coupling film disposed between the coupling region of the first multi-layered film and the coupling region of the second multi-layered film and configured to couple the first substrate and the second substrate to each other, in which the reflective region of the first multi-layered film and the reflective region of the second multi-layered film are disposed so as to be opposed to each other with a predetermined gap being interposed between the reflective region of the first multi-layered film and the reflective region of the second multi-layered film, the first multi-layered film and the second multi-layered film each include an optically stacked body stacked at the first substrate or the second substrate, and also each include an end-surface layer formed at an end surface of the optically stacked body, and at least a portion of the end-surface layer is electrically coupled to the first electrode portion or the second electrode portion.
(2) In the variable wavelength interference filter according to the present aspect, it is preferable to employ a configuration in which the optically stacked body includes an insulation-body layer, and a conductor layer or a semiconductor layer stacked with the insulation-body layer being interposed between the optically stacked body and the conductor layer or the semiconductor layer, and the end-surface layer is electrically coupled to the conductor layer or the semiconductor layer included in the optically stacked body.
(3) In the variable wavelength interference filter according to one aspect of the present disclosure, it is preferable to employ a configuration in which the electrode region of the second multi-layered film is separated from the reflective region and the coupling region, and the second electrode portion is electrically coupled to the end-surface layer formed at an end surface of the optically stacked body that constitutes the electrode region of the second multi-layered film.
(4) In the variable wavelength interference filter according to one aspect of the present disclosure, the first electrode portion and the second electrode portion may include a capacitance detecting electrode configured to detect a capacitance between the first electrode portion and the second electrode portion.
(5) In the variable wavelength interference filter according to one aspect of the present disclosure, the second electrode portion includes a plurality of electrodes, signals differing from each other being inputted into the electrodes, the electrode region of the second multi-layered film divided into a plurality of sub-electrode regions corresponding respectively to the electrodes, and the electrodes are electrically coupled to the end-surface layer formed at an end surface of the optically stacked body that constitutes the corresponding sub-electrode region.
(6) In the variable wavelength interference filter according to one aspect of the present disclosure, it is preferable to employ a configuration in which another end-surface layer is provided at an end surface of the optically stacked body that constitutes the reflective region of the second multi-layered film, the another end-surface layer being electrically coupled to a conductor layer or a semiconductor layer included in the optically stacked body.
(7) In the variable wavelength interference filter according to one aspect of the present disclosure, it is preferable to employ a configuration in which the electrode region of the first multi-layered film includes a plurality of sub-electrode regions that are adjacent to each other with the end-surface layer being interposed between them, the plurality of sub-electrode regions constituted by the optically stacked body.
(8) In the variable wavelength interference filter according to one aspect of the present disclosure, it is preferable to employ a configuration in which one substrate from among the first substrate and the second substrate includes: an opposing region where the first multi-layered film or the second multi-layered film is provided, this one substrate being opposed to the other substrate; an adjoining region adjoining the opposing region and exposed from the first multi-layered film or the second multi-layered film; and an alignment section provided in the adjoining region.

What is claimed is:

1. A variable wavelength interference filter comprising:
a first substrate;
a first multi-layered film provided at one surface of the first substrate and including a reflective region, an electrode region, and a coupling region that are regions differing from each other;
a first electrode portion provided at the electrode region of the first multi-layered film;
a second substrate disposed so as to be opposed to the first substrate;
a second multi-layered film provided at one surface of the second substrate and including a reflective region, an electrode region, and a coupling region that are regions differing from each other;
a second electrode portion provided at the electrode region of the second multi-layered film so as to be opposed to the first electrode portion, a signal being inputted into the second electrode portion; and
a coupling film disposed between the coupling region of the first multi-layered film and the coupling region of the second multi-layered film and configured to couple the first substrate and the second substrate to each other, wherein the reflective region of the first multi-layered film and
the reflective region of the second multi-layered film are disposed so as to be opposed to each other with a predetermined gap being interposed between the reflective region of the first multi-layered film and the reflective region of the second multi-layered film,
the first multi-layered film and the second multi-layered film each include an optically stacked body stacked at the first substrate or the second substrate, and also each include an end-surface layer formed at an end surface of the optically stacked body, and
at least a portion of the end-surface layer is electrically coupled to the first electrode portion or the second electrode portion.

2. The variable wavelength interference filter variable wavelength interference filter according to claim 1, wherein
the optically stacked body includes an insulation-body layer, and a conductor layer or a semiconductor layer stacked with the insulation-body layer being interposed between the optically stacked body and the conductor layer or the semiconductor layer, and
the end-surface layer is electrically coupled to the conductor layer or the semiconductor layer included in the optically stacked body.

3. The variable wavelength interference filter according to claim 1, wherein
the electrode region of the second multi-layered film is separated from the reflective region and the coupling region, and
the second electrode portion is electrically coupled to the end-surface layer formed at an end surface of the optically stacked body that constitutes the electrode region of the second multi-layered film.

4. The variable wavelength interference filter according to claim 3, wherein
the first electrode portion and the second electrode portion include a capacitance detecting electrode configured to detect a capacitance between the first electrode portion and the second electrode portion.

5. The variable wavelength interference filter according to claim 3, wherein
the second electrode portion includes a plurality of electrodes, signals differing from each other being inputted into the electrodes,
the electrode region of the second multi-layered film is divided into a plurality of sub-electrode regions corresponding respectively to the electrodes, and
the electrodes are electrically coupled to the end-surface layer formed at an end surface of the optically stacked body that constitutes the corresponding sub-electrode region.

6. The variable wavelength interference filter according to claim 3, wherein
the optically stacked body that constitutes the reflective region of the second multi-layered film includes a conductor layer or a semiconductor layer that is electrically coupled to the end-surface layer.

7. The variable wavelength interference filter according to claim 3, wherein
the electrode region of the first multi-layered film includes a plurality of sub-electrode regions that are adjacent to each other with the end-surface layer being interposed between sub-electrode regions, the plurality of sub-electrode regions constituted by the optically stacked body.

8. The variable wavelength interference filter according to claim 1, wherein
one substrate from among the first substrate and the second substrate includes:
an opposing region where the first multi-layered film or the second multi-layered film is provided, the one substrate being opposed to the other substrate;
an adjoining region adjoining the opposing region and exposed from the first multi-layered film or the second multi-layered film; and
an alignment section provided in the adjoining region.
